(19) United States
(12) Patent Application Publication
(10) Pub. No.: US 2024/0053444 A1
(43) Pub. Date: Feb. 15, 2024

(54) LASER RADAR

(71) Applicant: Hesai Technology Co., Ltd., Shanghai (CN)

(72) Inventors: Feng LIANG, Shanghai (CN); Jie CHEN, Shanghai (CN); Shaoqing XIANG, Shanghai (CN)

(21) Appl. No.: 18/383,429

(22) Filed: Oct. 24, 2023

Related U.S. Application Data
(63) Continuation of application No. PCT/CN2021/138323, filed on Dec. 15, 2021.

(30) Foreign Application Priority Data
Apr. 25, 2021 (CN) 202110446511.6

(51) Int. Cl. G01S 7/481; G01S 17/931; G01S 17/42

(52) U.S. Cl. CPC G01S 7/4815; G01S 17/931; G01S 7/4816; G01S 7/4817; G01S 17/42

(57) ABSTRACT

Provided is a LiDAR (100), comprising: a first transmitting unit (101) and a second transmitting unit (102), which are configured to respectively emit a first detection laser beam (L1) and a second detection laser beam (L2) to detect a target object; an optical assembly at a transmitting end and an receiving end optical assembly at a receiving end, the optical assembly at the transmitting end comprising a transmitting lens (103), and the optical assembly at the receiving end comprising a receiving lens (107); and a first receiving unit (105) and a second receiving unit (106), configured to respectively receive a first echo (L1′) and a second echo (L2′) reflected by a object of the first detection laser beam (L1) and the second detection laser beam (L2), convert them into electrical signals, wherein the first detection laser beam (L1) and the second detection laser beam (L2) are respectively emitted from the first transmitting unit (101) and a second transmitting unit (102) and then pass through different optical distances before reaching the transmitting lens (103), and the first echo (L1′) and the second echo (L2′) respectively travel through different optical distances from the receiving lens (107) before reaching the first receiving unit (105) and the second receiving unit (106).

### TECHNICAL FIELD

The present disclosure relates to the technical field of photoelectric detection, and in particular, to a LiDAR capable of satisfying both long-range detection and short-range detection performances.

### BACKGROUND

LiDAR is a radar system that can emit laser beams to detect the position, velocity, and other feature quantities of an object. LiDAR is an advanced detection technique that combines laser technology with photoelectric detection technology. Because of its advantages such as high resolution, good concealment, strong resistance to active interference, great low-altitude detection performance, small size, and light weight, LiDAR is widely used in fields such as autonomous driving, intelligent transportation, unmanned aerial vehicles, intelligent robots, and resource exploration.

Currently, there are two representative application scenarios for LiDARs used for autonomous driving. The first scenario is long-range and small vertical field of view (FOV) detection, which is typically required to detect objects beyond 150 m at a vertical FOV of 15° to 40°. This scenario is used for fine detection of objects at medium to long range. The other scenario is short-range and large vertical FOV detection, which typically covers a detection distance of 15 m to 50 m and a vertical FOV of 80° to 105°. This scenario is used for blind zone detection at short range. These two applications are typically implemented independently with two types of LiDARs, and then they are installed together on a platform like an autonomous vehicle to achieve detection without blind zone at both long and short ranges, as illustrated in FIG. 1.

If these two detection demands can be met by one LiDAR, this will definitely be very meaningful. However, these two detection demands have completely different design requirements for LiDAR. If the detection distance is to be achieved as far as possible, the optical path of the detector needs to be designed with a long focal length. If a large FOV is to be achieved, a short focal length needs to be adopted.

If vertical FOV of a long-range measuring LiDAR (having an optical path with a long focal length, as illustrated in FIG. 2a) is directly increased, this will greatly increase the height of the receiving surface of the detector, as illustrated in FIG. 3a, thereby increasing the height of the LiDAR significantly, unfavorable for improving the integration of the LiDAR. In a short-range measuring LiDAR (having an optical path with a short focal length, as illustrated in FIG. 2b), if beams are added at the central region to ensure the resolution of the long-range detection, as illustrated in FIG. 3b, on the one hand, it will be difficult to increase the number of beams at the central region subject to the size of a single detector, and on the other hand, because of the optical path with the short focal length, the long-range detection performance will be hardly improved.

The content of the “Background” merely involves the technology known to the inventor and does not necessarily represent the prior art in the field.

### SUMMARY

In view of at least a drawback of the exist technology, the present disclosure provides a LiDAR, comprising:
a first transmitting unit and a second transmitting unit, configured to respectively emit a first detection laser beam and a second detection laser beam for detecting an object;
an optical assembly at a transmitting end and an optical assembly at a receiving end, the optical assembly at the transmitting end comprising a transmitting lens, and the optical assembly at the receiving end comprising a receiving lens; and
a first receiving unit and a second receiving unit, configured to respectively receive a first echo and a second echo of the first detection laser beam and the second detection laser beam reflected by the object, and convert them into electrical signals,
wherein the first detection laser beam and the second detection laser beam respectively exit from the first transmitting unit and the second transmitting unit and then travel through different optical distances before reaching the transmitting lens, and the first echo and the second echo respectively travel through different optical distances from the receiving lens before reaching the first receiving unit and the second receiving unit.

According to an aspect of the present disclosure, the first transmitting unit and the second transmitting unit are respectively disposed at different positions from the transmitting lens, and the first receiving unit and the second receiving unit are respectively disposed at different positions from the receiving lens.

According to an aspect of the present disclosure, the first transmitting unit comprises a first array of lasers disposed on a focal plane of the transmitting lens; the second transmitting unit comprises a second array of lasers, a distance between the second array of lasers and the transmitting lens being less than a focal length of the transmitting lens; the first receiving unit comprises a first array of detectors disposed on a focal plane of the receiving lens; and the second receiving unit comprises a second array of detectors, a distance between the second array of detectors and the receiving lens being less than a focal length of the receiving lens.

According to an aspect of the present disclosure, the second transmitting unit comprises a focus-changing lens at the transmitting end, disposed between the second array of lasers and the transmitting lens, the second detection laser beam passing through the focus-changing lens at the transmitting end and the transmitting lens before exiting to the outside of the LiDAR; the second receiving unit comprises a focus-changing lens at the receiving end, disposed between the second array of detectors and the receiving lens, the second echo passing through the receiving lens and the focus-changing lens at the receiving end before being incident onto the second array of detectors.

According to an aspect of the present disclosure, the LiDAR further comprises one or more mirrors at the transmitting end and one or more mirrors at the receiving end, the first detection laser beam being reflected by the mirror at the transmitting end and then exiting through the transmitting lens, and the first echo being reflected by the mirror at the receiving end and then being incident onto the first array of detectors.

According to an aspect of the present disclosure, the mirror at the transmitting end comprises a mirror with an opening, wherein the first detection laser beam is reflected by the mirror with the opening at the transmitting end and then exits through the transmitting lens, and the second detection laser beam passes through the opening and exits through the transmitting lens; and the mirror at the receiving end comprises a mirror with an opening, wherein the first echo is reflected by the mirror at the receiving end with the opening at the receiving end and then is incident onto the first array of detectors, and the second echo passes through the opening and is incident onto the second array of detectors.

According to an aspect of the present disclosure, the LiDAR has a rotating shaft and an opto-mechanical rotor rotatable about the rotating shaft, the opto-mechanical rotor comprising the first transmitting unit, the second transmitting unit, the optical assembly at the transmitting end, the optical assembly at the receiving end, the first receiving unit and the second receiving unit, wherein the opto-mechanical rotor is disposed above the rotating shaft, or the rotating shaft extends through the opto-mechanical rotor.

According to an aspect of the present disclosure, the optical assembly at the transmitting end comprises a first transmitting lens and a second transmitting lens, and the optical assembly at the receiving end comprises a first receiving lens and a second receiving lens, the first detection laser beam exiting through the first transmitting lens, and the second detection laser beam exiting through the second transmitting lens; and the first echo being converged to the first detection unit through the first receiving lens, and the second echo being converged to the second detection unit through the second receiving lens.

According to an aspect of the present disclosure, the LiDAR has a rotating shaft, the first transmitting lens and the second transmitting lens being substantially 180 degree opposed about the rotating shaft, and the first receiving lens and the second receiving lens being substantially 180 degree opposed about the rotating shaft.

According to an aspect of the present disclosure, the first transmitting lens and the first receiving lens comprise a telecentric lens group.

According to an aspect of the present disclosure, the first detection laser beam and the second detection laser beam correspond to different vertical field of view ranges of the LiDAR.

According to an aspect of the present disclosure, the energy of the first detection laser beam is higher than that of the second detection laser beam.

According to an aspect of the present disclosure, the first transmitting unit and the second transmitting unit both comprise a plurality of lasers and multi-channel driving chips, the plurality of lasers and multi-channel driving chips being disposed on the same PCB; and the first receiving unit and the second receiving unit both comprise a plurality of detectors and multi-channel front-end chips, the plurality of detectors and multi-channel front-end chips being disposed on the same PCB.

According to an aspect of the present disclosure, the LiDAR further comprises a data processing unit coupled with the first transmitting unit, the second transmitting unit, the first receiving unit and the second receiving unit, and the data processing unit is used for fusing detection results of the first detection laser beam and the second detection laser beam to generate a point cloud.

The embodiments of the present disclosure propose a solution that can merge small-FOV long-range detection and large-FOV short-range detection together. A LiDAR according to an embodiment of the present disclosure is capable of achieving detection at short range and large vertical field of view and detection at long range and small vertical field of view while ensuring a compact structure.

### BRIEF DESCRIPTION OF THE DRAWINGS

The drawings that constitute part of the present disclosure are provided for further understanding the present disclosure, which, along with the embodiments of the present disclosure and description thereof, are used for explaining the present disclosure, and do not make any improper limitation of the same. In the drawings:

FIG. 1 illustrates a schematic diagram of the combined use of existing LiDARs for long-range detection and for short-range detection;

FIG. 2a illustrates a schematic diagram of an optical path with along focal length of a LiDAR for long-range and small vertical FOV detection;

FIG. 2b illustrates a schematic diagram of an optical path with a short focal length of a LiDAR for short-range and large vertical FOV detection;

FIG. 3a illustrates a schematic diagram of an optical path with along focal length of a LiDAR satisfying both long-range and short-range detection at a large vertical FOV;

FIG. 3b illustrates a schematic diagram of an optical path with a short focal length of a LiDAR satisfying both long-range and short-range detection at a large vertical FOV;

FIG. 4a illustrates a schematic diagram of an optical path structure on the transmitting side of a LiDAR according to one embodiment of the present disclosure;

FIG. 4b illustrates a schematic diagram of an optical path structure on the transmitting side of a LiDAR according to one embodiment of the present disclosure;

FIG. 4c illustrates a schematic diagram of an optical path structure on the receiving side of a LiDAR according to one embodiment of the present disclosure;

FIG. 5 illustrates a schematic top view of a LiDAR according to one embodiment of the present disclosure, which has a bifocal length structure;

FIG. 6 illustrates a schematic diagram of a LiDAR according to another embodiment of the present disclosure, where there are a plurality of mirrors;

FIG. 7a illustrates a schematic diagram of a LiDAR with non-through shaft;

FIG. 7b illustrates a schematic diagram of a LiDAR with through shaft;

FIG. 8 illustrates a schematic diagram of a LiDAR according to another embodiment of the present disclosure;

FIG. 9 illustrates a telecentric lens group for a LiDAR according to one embodiment of the present disclosure;

FIG. 10a illustrates a transmitting unit according to one embodiment of the present disclosure; and

FIG. 10b illustrates a receiving unit according to one embodiment of the present disclosure.

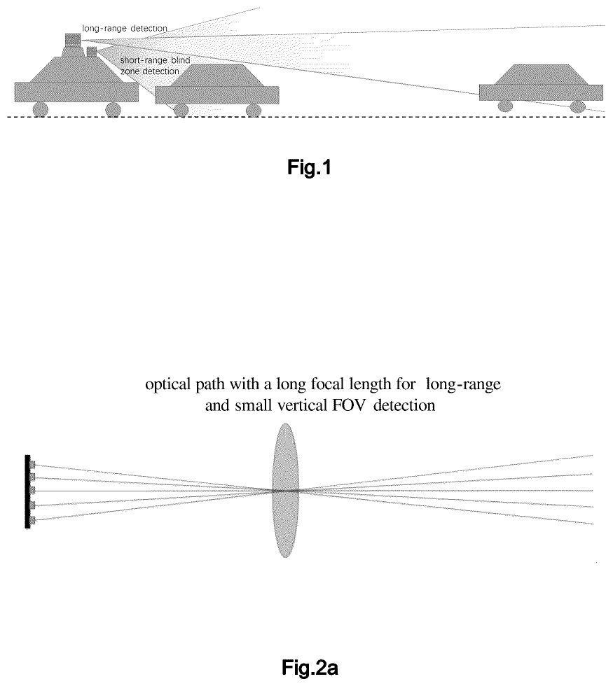

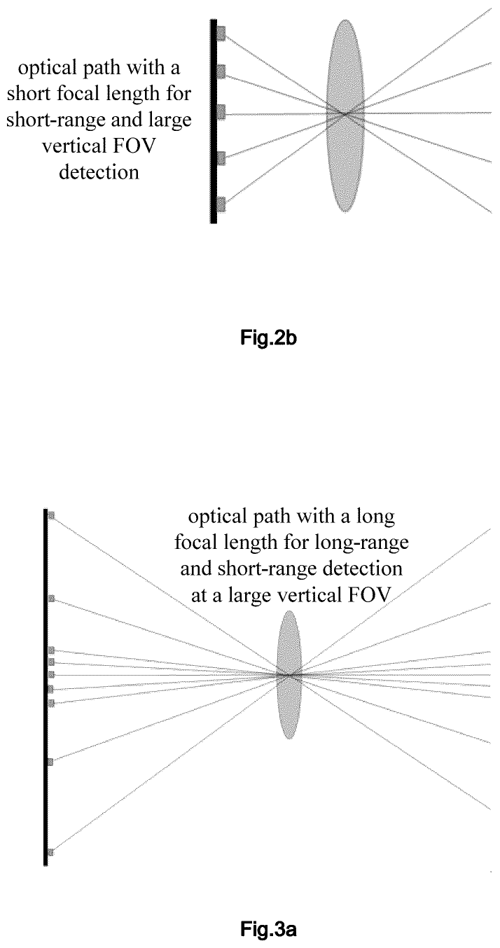

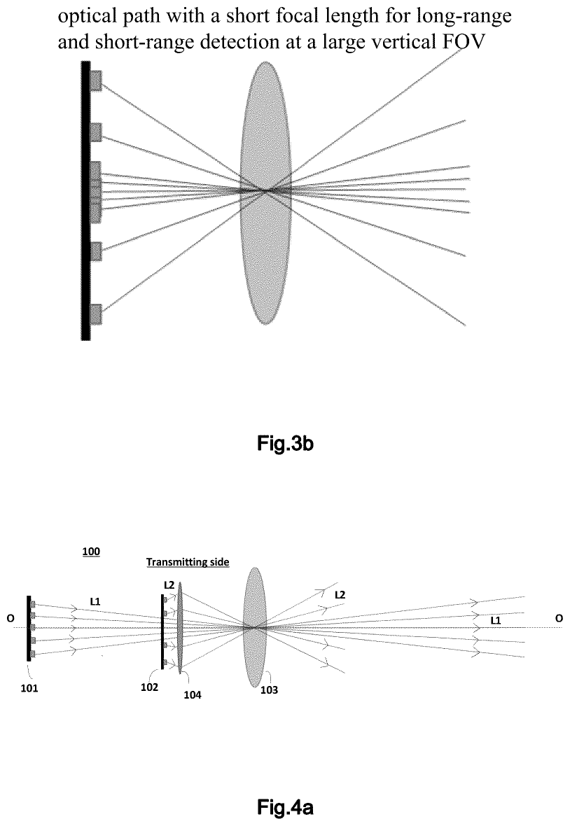

### DETAILED DESCRIPTION OF THE EMBODIMENTS

In the following, only some exemplary embodiments are briefly described. The described embodiments may be modified in various different ways without departing from the spirit or scope of the present disclosure, as would be apparent to those skilled in the art. Accordingly, the drawings and descriptions are to be regarded as illustrative and not restrictive in nature.

In the description of the present disclosure, it needs to be understood that the orientation or position relations denoted by such terms as “central” “longitudinal” “latitudinal” “length” “width” “thickness” “above” “below” “front” “rear” “left” “right” “vertical” “horizontal” “top” “bottom” “inside” “outside” “clockwise” “counterclockwise” and the like are based on the orientation or position relations as shown in the accompanying drawings, and are used only for the purpose of facilitating description of the present disclosure and simplification of the description, instead of indicating or suggesting that the denoted devices or elements must be oriented specifically, or configured or operated in a specific orientation. Thus, such terms should not be construed to limit the present disclosure. In addition, such terms as “first” and “second” are only used for the purpose of description, rather than indicating or suggesting relative importance or implicitly indicating the number of the denoted technical features. Accordingly, features defined with “first” and “second” may, expressly or implicitly, include one or more of the features. In the description of the present disclosure, “plurality” means two or more, unless otherwise defined explicitly and specifically.

In the description of the present disclosure, it needs to be noted that, unless otherwise specified and defined explicitly, such terms as “installation” “coupling” and “connection” should be broadly understood as, for example, fixed connection, detachable connection, or integral connection; or mechanical connection, electrical connection or intercommunication; or direct connection, or indirect connection via an intermediary medium; or internal communication between two elements or interaction between two elements. For those skilled in the art, the specific meanings of such terms herein can be construed in light of the specific circumstances.

Herein, unless otherwise specified and defined explicitly, if a first feature is “on” or “beneath” a second feature, this may cover direct contact between the first and second features, or contact via another feature therebetween, other than the direct contact. Furthermore, if a first feature is “on”, “above”, or “over” a second feature, this may cover the case that the first feature is right above or obliquely above the second feature, or just indicate that the level of the first feature is higher than that of the second feature. If a first feature is “beneath”, “below”, or “under” a second feature, this may cover the case that the first feature is right below or obliquely below the second feature, or just indicate that the level of the first feature is lower than that of the second feature.

The disclosure below provides many different embodiments or examples so as to realize different structures described herein. In order to simplify the disclosure herein, the following will give the description of the parts and arrangements embodied in specific examples. Of course, they are only for the exemplary purpose, not intended to limit the present disclosure. Besides, the present disclosure may repeat a reference number and/or reference letter in different examples, and such repeat is for the purpose of simplification and clarity, which does not represent any relation among various embodiments and/or arrangements as discussed. In addition, the present disclosure provides examples of various specific processes and materials, but those skilled in the art can also be aware of application of other processes and/or use of other materials.

On the basis of existing photoelectric devices (lasers and detectors), in order to enable a LiDAR to simultaneously satisfy both long-range and short-range detection performances without significantly increasing the height of the LiDAR, the inventors of the present disclosure conceive that a plurality of transmitting units and a plurality of receiving units can be respectively provided in the LiDAR, for example, two transmitting units and two receiving units, wherein one transmitting unit and one receiving unit are used for detecting a long-range object at a smaller FOV, while the other transmitting unit and the other receiving unit are used for detecting a short-range object at a larger FOV; it has both a transmitting lens and a receiving lens, wherein different detection laser beams emitted from the plurality of transmitting units travel through different optical distances before reaching the transmitting lens, and then exit into the surrounding environment after passing through the transmitting lens, and echoes generated on the object travel respectively through different optical distances from the receiving lens before reaching different receiving units, that is, a transmit-receive pair consisting of one transmitting unit and one receiving unit and a transmit-receive pair consisting of the other transmitting unit and the other receiving unit correspond to different focal lengths. Therefore, the LiDAR according to the embodiment of the present disclosure can simultaneously integrate the functions of large-FOV short-range detection and small-FOV long-range detection.

The preferred embodiments of the present disclosure will be described below with reference to the drawings. It should be appreciated that the preferred embodiments described here are only for the purpose of illustrating and explaining, instead of limiting, the present disclosure.

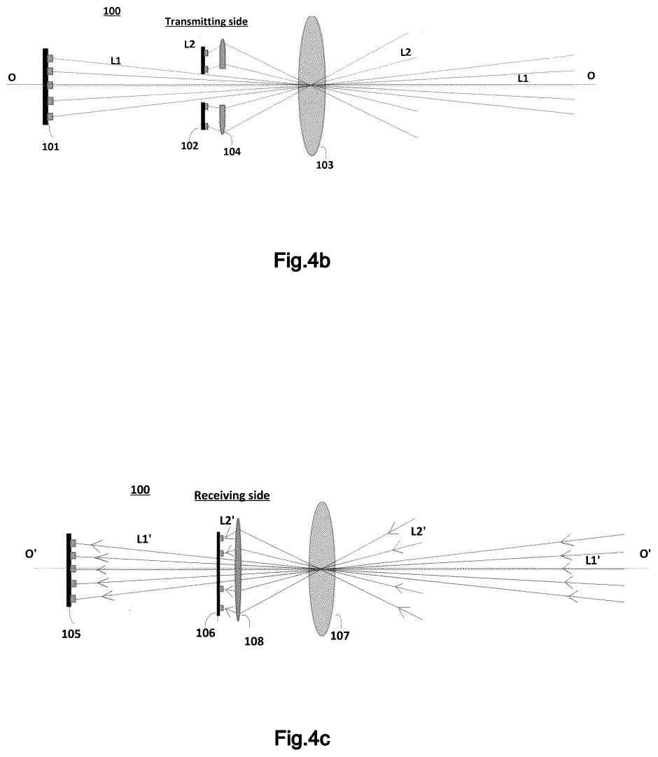

FIGS. 4a, 4b and 4c illustrate schematic diagrams of a LiDAR 100 according to one embodiment of the present disclosure, of which FIGS. 4a and 4b illustrate an optical path structure on the transmitting side of the LiDAR, and FIG. 4c illustrates an optical path structure on the receiving side of the LiDAR. The following is described in detail with reference to the accompanying drawings.

As illustrated in FIG. 4a, the LiDAR 100 on its transmitting side comprises a first transmitting unit 101 and a second transmitting unit 102, wherein the first transmitting unit 101 comprises a first array of lasers disposed on a circuit board and used for emitting a first detection laser beam L1, and the second transmitting unit 102 also comprises a second array of lasers disposed on a circuit board and used for emitting a second detection laser beam L2. Lasers in the first and second arrays of lasers can include a vertical cavity surface emitting laser (VCSEL) or an edge emitting laser (EEL).

The LiDAR 100 further comprises an optical assembly at the transmitting end for modulating (e.g., collimating) the first detection laser beam L1 and the second detection laser beam L2, and then enabling them exit into the surrounding environment of the LiDAR for detecting objects. As illustrated in FIG. 4a, the optical assembly at the transmitting end comprises a transmitting lens 103 configured to collimate the first detection laser beam L1 and the second detection laser beam L2. As illustrated in FIG. 4a, the first detection laser beam L1 and the second detection laser beam L2 respectively exit from the first transmitting unit 101 and the second transmitting unit 102 and travel through different optical distances before reaching the transmitting lens 103, wherein an optical distance the first detection laser beam L1 travels through is, for example, longer than an optical distance the second detection laser beam L2 travels through.

In order to enable the first detection laser beam L1 and the second detection laser beam L2 to travel through different optical distances, the first transmitting unit 101 and the second transmitting unit 102 can be respectively disposed at different positions from the transmitting lens 103, for example. Preferably, the first array of lasers of the first transmitting unit 101 is disposed on a focal plane of the transmitting lens 103, and a distance between the second array of lasers of the second transmitting unit 102 and the transmitting lens 103 is less than a focal length of the transmitting lens 103.

According to one preferred embodiment of the present disclosure, as illustrated in FIG. 4a, the LiDAR further comprises a focus-changing lens at the transmitting end 104 disposed between the second array of lasers of the second transmitting unit 102 and the transmitting lens 103, the second detection laser beam L2 exiting to the outside of the LiDAR after passing through the focus-changing lens at the transmitting end 104 and the transmitting lens 103. As illustrated in FIG. 4a, the second detection laser beam L2 undergoes a certain change in its direction or divergence after passing through the focus-changing lens at the transmitting end 104, and then incident onto the transmitting lens 103 and exits to the outside of the LiDAR. Preferably, the second array of lasers of the second transmitting unit 102 is located on a focal plane of a lens group consisting of the focus-changing lens at the transmitting end 104 and the transmitting lens 103, and an equivalent focal length of the lens group consisting of the focus-changing lens at the transmitting end 104 and the transmitting lens 103 is smaller than the focal length of the transmitting lens 103.

Additionally, FIGS. 4a, 4b and 4c are not only schematic diagrams of the LiDAR 100 according to one embodiment of the present disclosure, and FIGS. 4a and 4b are also schematic diagrams of a coaxial arrangement of the first transmitting unit 101 and the second transmitting unit 102 on the transmitting side, that is, both the first transmitting unit 101 and the second transmitting unit 102 are arranged along an optical axis OO of the transmitting lens 103. The coaxial arrangement of the first transmitting unit 101 and the second transmitting unit 102 can be implemented in different ways. For example, an opening can be made on the circuit board of the second transmitting unit 102, and an opening be made at the center of the focus-changing lens at the transmitting end 104, for allowing the first detection laser beam L1 to pass through. Therefore, the first detection laser beam L1 is not modulated by the focus-changing lens at the transmitting end 104. In this case, the first array of lasers of the first transmitting unit 101 can be disposed relatively densely, and located substantially in a middle position of the circuit board; and the second array of lasers of the second transmitting unit 102 can be disposed relatively sparsely, and located substantially in an edge position of the circuit board. Additionally, or alternatively, as illustrated in FIG. 4b, the second transmitting unit 102 can also be divided into two parts spaced from each other, the focus-changing lens at the transmitting end 104 can also be divided into two parts spaced from each other, and a middle spacing region of the second transmitting unit 102 and a middle spacing region of the focus-changing lens at the transmitting end 104 can be used for allowing the first detection laser beam L1 to pass through. Additionally, the aforesaid embodiments can also be combined by, for example, making an opening in the middle of the circuit board of the second transmitting unit 102 and dividing the focus-changing lens at the transmitting end 104 into two parts; or vice versa.

Additionally, those skilled in the art can also conceive of using a microlens array (MLA) to implement the focus-changing lens at the transmitting end 104. For example, a microlens is disposed downstream of an optical path of each laser in the second array of lasers of the second transmitting unit 102, such that the second detection laser beam L2 is modulated by the microlens and then projected to the transmitting lens 103. In addition to this, other arrangement ways can also be conceived, which will be described in detail in the following embodiments.

In the structures of FIGS. 4a and 4b, the transmitting lens 103 can adopt a typical design for a LiDAR for long-range detection with a relatively large focal length, such that the first array of lasers of the first transmitting unit 101 is directly disposed at the focal plane of the transmitting lens 103, which can conveniently achieve high beam number and high resolution within a small FOV range. One focus-changing lens at the transmitting end 104 is added at the second transmitting unit 102. A focal length of the lens group consisting of the focus-changing lens at the transmitting end 104 and the transmitting lens 103 is relatively small, which is smaller than the focal length of the transmitting lens 103. Therefore, short-range detection and scanning at a large FOV can be implemented, and the height of the transmitting surface of the lasers will not be very great at the same time, which thus can achieve a compact structure. Preferably, the first detection laser beam L1 (a long-range detection beam) and the second detection laser beam L2 (a short-range detection beam) do not overlap in the vertical field of view, and emergent lights of lasers for short-range and long-range detection have different energies. According to one preferred embodiment of the present disclosure, the energy of the first detection laser beam L1 for long-range detection is higher than that of the second detection laser beam L2 for short-range detection.

As illustrated in FIG. 4c, the LiDAR 100 on its receiving side comprises a first receiving unit 105 and a second receiving unit 106, the first receiving unit 105 comprising a first array of detectors, and the second receiving unit 106 comprising a second array of detectors. The first array of detectors and the second array of detectors can include various types of photodetectors, such as an avalanche photodiode (APD), a single photon avalanche diode (SPAD), or a silicon photomultiplier (SiPM). After the first detection laser beam L1 and the second detection laser beam L2 undergo diffuse reflection on the objects, a first echo L1′ and a second echo L2′ are respectively generated and return to the LiDAR, and are converged by a receiving lens 107 onto the first receiving unit 105 and the second receiving unit 106, and the first receiving unit 105 and the second receiving unit 106 are configured to respectively receive the first echo L1′ and the second echo L2′ and convert them into electrical signals for signal processing and analysis in subsequent circuits. Among them, the first echo L1′ and the second echo L2′ respectively travel through different optical distances from the receiving lens 107 before reaching the first receiving unit 105 and the second receiving unit 106, wherein an optical distance the first echo L1′ travels through is, for example, greater than an optical distance the second echo L2′ travels through.

In order to enable the first echo L1′ and the second echo L2′ to respectively travel through different optical distances before reaching the first receiving unit 105 and the second receiving unit 106, the first receiving unit 105 and the second receiving unit 106 can be respectively disposed at different positions from the receiving lens 107. For example, the first array of detectors of the first receiving unit 105 can be disposed on a focal plane of the receiving lens 107, and a distance between the second array of detectors of the second receiving unit 106 and the receiving lens 107 can be set to be less than a focal length of the receiving lens 107.

According to one preferred embodiment of the present disclosure, as illustrated in FIG. 4c, the LiDAR 100, on the receiving side, further comprises a focus-changing lens at the receiving end 108 disposed between the second array of detectors of the second receiving unit 106 and the receiving lens 107, the second echo L2′ being incident onto the second array of detectors after passing through the receiving lens 107 and the focus-changing lens at the receiving end 108. As illustrated in FIG. 4c, the second echo L2′ undergoes a certain change in its direction or divergence after passing through the focus-changing lens at the receiving end 108, and then is incident onto the second array of detectors. Preferably, the second array of detectors of the second receiving unit 106 is located on a focal plane of a lens group consisting of the focus-changing lens at the receiving end 108 and the receiving lens 107, and an equivalent focal length of the lens group consisting of the focus-changing lens at the receiving end 108 and the receiving lens 107 is smaller than the focal length of the receiving lens 107.

Additionally, those skilled in the art can also conceive of using a microlens array (MLA) to implement the focus-changing lens at the receiving end 108. For example, a microlens is disposed upstream of an optical path of each detector in the second array of detectors of the second receiving unit 106 to modulate the second echo L2′.

Additionally, FIGS. 4a, 4b and 4c are not only schematic diagrams of the LiDAR 100 according to one embodiment of the present disclosure, and FIG. 4c is also a schematic diagram of a coaxial arrangement of the first receiving unit 105 and the second receiving unit 106 on the receiving side, that is, both the first receiving unit 105 and the second receiving unit 106 are arranged along an optical axis O′O′ of the receiving lens 107. Similarly, the coaxial arrangement of the first receiving unit 105 and the second receiving unit 106 can be implemented in different ways. For example, an opening can be made on the circuit board of the second receiving unit 106, and an opening be made at the center of the focus-changing lens at the receiving end 108, for allowing the first echo L1′ to pass through. Therefore, the first echo L1′ is not modulated by the focus-changing lens at the receiving end 108. In this case, the first array of detectors of the first receiving unit 105 can be disposed relatively densely, and located substantially in a middle position of the circuit board; and the second array of detectors of the second receiving unit 106 can be disposed relatively sparsely, and located substantially in an edge position of the circuit board.

Additionally, or alternatively, the second receiving unit 106 can also be divided into two parts spaced from each other, the focus-changing lens at the receiving end 108 can also be divided into two parts spaced from each other, and a middle spacing region of the second receiving unit 106 and a middle spacing region of the focus-changing lens at the receiving end 108 can be used for allowing the first echo L1′ to pass through. Additionally, the aforesaid embodiments can also be combined by, for example, making an opening in the middle of the circuit board of the second receiving unit 106 and dividing the focus-changing lens at the receiving end 108 into two parts; or vice versa.

Additionally, those skilled in the art can also conceive of using a microlens array (MLA) to implement the focus-changing lens at the receiving end 108. For example, a microlens is disposed upstream of an optical path of each detector in the second array of detectors of the second receiving unit 106, such that the second echo L2′ passing through the receiving lens 107 is modulated by the microlens and then is incident onto the detector. In addition to this, there can also be other arrangement ways, which will be described in detail in the following embodiments.

The receiving lens 107 can adopt a typical design for a LiDAR for long-range detection with a relatively large focal length, such that the first array of detectors of the first receiving unit 105 can be directly disposed at the focal plane of the receiving lens 107, which can conveniently achieve high beam number and high resolution within a small FOV range. One focus-changing lens at the receiving end 108 is added in the proximity of the second receiving unit 106. A focal length of the lens group consisting of the focus-changing lens at the receiving end 108 and the receiving lens 107 is relatively small, which is smaller than the focal length of the receiving lens 107. Therefore, a large FOV can be achieved, and the height of the receiving surface of the detectors will not be very high, which thus can achieve a compact structure. According to one preferred embodiment of the present disclosure, the first array of detectors of the first receiving unit 105 for long-range detection has a sensitivity higher than that of the second array of detectors of the second receiving unit 106 for short-range detection.

The LiDAR illustrated in FIGS. 4a, 4b and 4c of the present disclosure is a LiDAR with a bifocal length structure, which enables the LiDAR 100 to implement the functions of short-range detection with a large vertical FOV and long-range detection with a small vertical FOV at the same time, and the height of the LiDAR does not to significantly increase. Specifically, two transmitting units are disposed on the transmitting side of the LiDAR, which are respectively used for emitting the first detection laser beam (for long-range detection) and the second detection laser beam (for short-range detection), and two receiving units are disposed on the receiving side, which are respectively used for receiving echoes generated by the first detection laser beam and the second detection laser beam, i.e., for long-range detection and short-range detection, respectively. A transmit-receive pair consisting of one transmitting unit and one receiving unit (for long-range detection) and a transmit-receive pair consisting of the other transmitting unit and the other receiving unit (for short-range detection) correspond to different focal lengths, thereby satisfying both long-range detection and short-range detection performances of the LiDAR in a compact structure.

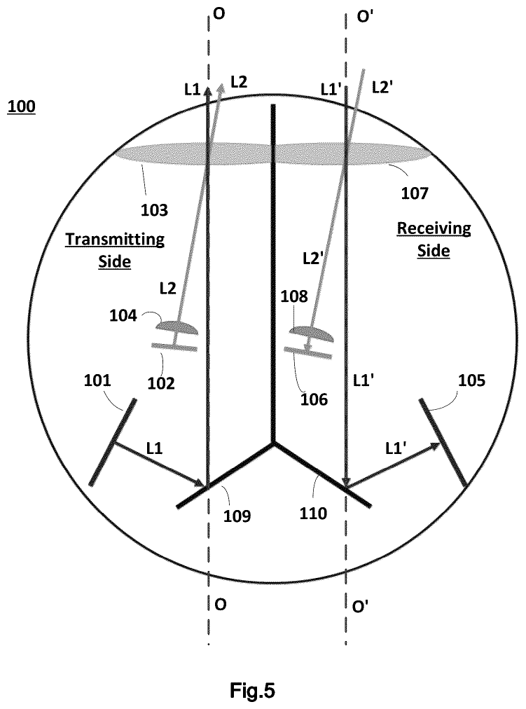

FIG. 5 illustrates a schematic top view of a LiDAR 100 according to one embodiment of the present disclosure, which also has a bifocal length structure. Unlike FIGS. 4a, 4b and 4c, FIG. 5 illustrates non-coaxial arrangement of the first transmitting unit 101 and the second transmitting unit 102, which means that they are not arranged along the optical axis OO of the transmitting lens 103, and non-coaxial arrangement of the first receiving unit 105 and the second receiving unit 106, which means that they are not arranged along the optical axis O′O′ of the receiving lens 107. As illustrated in FIG. 5, on the transmitting side, the LiDAR 100 further comprises a mirror at the transmitting end 109 in addition to the first transmitting unit 101, the second transmitting unit 102, the transmitting lens 103 and the focus-changing lens at the transmitting end 104. The mirror at the transmitting end 109 is located between the first transmitting unit 101 and the transmitting lens 103 and used for receiving the first detection laser beam L1, such that the first detection laser beam L1, after being reflected by the mirror at the transmitting end 109, exits through the transmitting lens 103. The second detection laser beam L2 emitted by the second transmitting unit 102 is modulated by the focus-changing lens at the transmitting end 104 and then exits through the transmitting lens 103. Preferably, as illustrated in FIG. 5, the second transmitting unit 102 and the focus-changing lens at the transmitting end 104 are disposed at such positions as to avoid the propagation path of the first detection laser beam L1, with both the first detection beam L1 and the second detection laser beam L2 pointing towards the center of the lens and exiting, and the first detection beam L1 and the second detection laser beam L2 having a relatively small angle difference in a horizontal direction (the direction of the surface of FIG. 5 is a horizontal direction, and the direction vertical to the surface is a vertical direction) (the angle difference is 0 in FIGS. 4a, 4b and 4c). Compared with the embodiments in FIGS. 4a, 4b and 4c, the embodiment in FIG. 5 can enable the structure on the transmitting side of the LiDAR to be more compact (the height to be lower) by disposing the mirror 109.

Similarly, on the receiving side, the LiDAR 100 further comprises a mirror at the receiving end 110 in addition to the first receiving unit 105, the second receiving unit 106, the receiving lens 107 and the focus-changing lens at the receiving end 108. The mirror at the receiving end 110 is located between the first receiving unit 105 and the receiving lens 107 and used for receiving the first echo L1′, such that the first echo L′, after being reflected by the mirror at the receiving end 110, is incident onto the first receiving unit 105. The second echo L2′ is incident onto the second receiving unit 106 after passing through the receiving lens 107 and the focus-changing lens at the receiving end 108. Preferably, as illustrated in FIG. 5, the second receiving unit 106 and the focus-changing lens at the receiving end 108 are disposed at such positions as to avoid the propagation path of the first echo L1′. By disposing the mirror 110, the structure on the receiving side of the LiDAR can be made more compact. The first receiving unit 105 and the second receiving unit 106 can share a signal processing unit.

In the embodiment illustrated in FIG. 5, one mirror is respectively disposed on the transmitting and receiving sides of the LiDAR. The present disclosure is not limited to this, and a plurality of mirrors can also be arranged. Additionally, mirrors can also be arranged to change the directions of the second detection laser beam L2 and the second echo L2′. These all fall within the scope of protection of the present disclosure.

In the embodiment illustrated in FIG. 5, the array of lasers of the first transmitting unit 101 emits a light beam for long-range measuring, which is reflected once by the mirror at the transmitting end 109 and then exits through the transmitting lens 103 (the main transmitting lens). After the light beam for long-range measuring is reflected by an obstacle, an echo is received by the receiving lens 107 (the main receiving lens), reflected once by the mirror at the receiving end 110, then detected by the array of detectors of the first receiving unit 105, and then processed by a subsequent processing unit to obtain ranging data. The aforesaid detection process corresponds to long-range small-FOV detection.

The array of lasers of the second transmitting unit 102 emits a light beam for short-range measuring, which passes through the focus-changing lens at the transmitting end 104 and then exits through the transmitting lens 103. After the light beam for short-range measuring is reflected by an obstacle, an echo is received by the receiving lens 107, detected by the array of detectors of the second receiving unit 106 after passing through the focus-changing lens at the receiving end 108, and then processed by a subsequent processing unit to obtain ranging data. The aforesaid detection process corresponds to short-range large-FOV detection. The readout signals of the array of detectors of the first receiving unit 105 and the array of detectors of the second receiving unit 106 can share a signal processing unit.

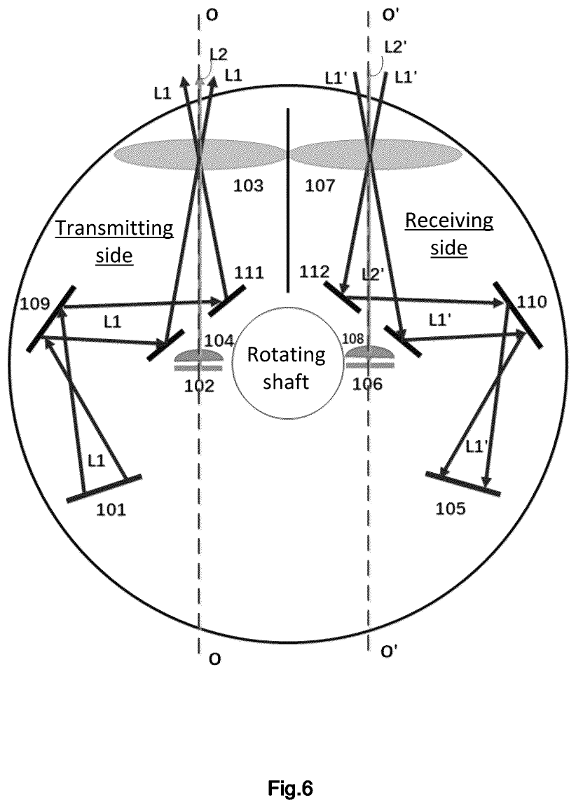

FIG. 6 illustrates a LiDAR according to another embodiment of the present disclosure. In FIG. 6, the first transmitting unit 101 and the second transmitting unit 102 are also arranged non-coaxially, that is, not arranged along the optical axis OO of the transmitting lens 103, and the first receiving unit 105 and the second receiving unit 106 are also arranged non-coaxially, that is, not arranged along the optical axis O′O′ of the receiving lens 107. Unlike the embodiment of FIG. 5, the LiDAR in the embodiment of FIG. 6 has a plurality of mirrors. As illustrated in FIG. 6, on the transmitting side of the LiDAR 100, in addition to the first transmitting unit 101, the second transmitting unit 102, the transmitting lens 103, and the focus-changing lens at the transmitting end 104, the LiDAR 100 further comprises a first mirror at the transmitting end 109 and a second mirror at the transmitting end 111. The first mirror at the transmitting end 109 and the second mirror at the transmitting end 111 are located in sequence between the first transmitting unit 101 and the transmitting lens 103, and used for reflecting the first detection laser beam L1. The first detection laser beam L1 is reflected by the first mirror at the transmitting end 109 and the second mirror at the transmitting end 111 in sequence, and then exits through the transmitting lens 103. The second detection laser beam L2 emitted by the second transmitting unit 102 exits through the transmitting lens 103 after being modulated by the focus-changing lens at the transmitting end 104. Preferably, as illustrated in FIG. 6, the first mirror at the transmitting end 109 is disposed at such a position as to avoid the propagation path of the second detection laser beam L2, and the second mirror at the transmitting end 111 is disposed on the propagation path of the second detection laser beam L2. An opening can be made on the second mirror at the transmitting end 111 to allow the second detection laser beam L2 to pass therethrough, while the remaining positions of the second mirror at the transmitting end 111 are used for reflecting the first detection laser beam L1, as illustrated in FIG. 6.

Similarly, on the receiving side, the LiDAR 100 further comprises a first mirror at the receiving end 110 and a second mirror at the receiving end 112 in addition to the first receiving unit 105, the second receiving unit 106, the receiving lens 107, and the focus-changing lens at the receiving end 108. The first mirror at the receiving end 110 and the second mirror at the receiving end 112 are located in sequence between the first receiving unit 105 and the receiving lens 107, and used for reflecting the first echo L1′. The first echo L1′ is reflected by the second mirror at the receiving end 112 and the first mirror at the receiving end 110 in sequence, and then incident onto the first receiving unit 105. The second echo L2′ is incident onto the second receiving unit 106 after passing through the receiving lens 107 and the focus-changing lens at the receiving end 108. Preferably, as illustrated in FIG. 6, the first mirror at the receiving end 110 is disposed at such a position as to avoid the propagation path of the second echo L2′, and the second mirror at the receiving end 112 is disposed on the propagation path of the second echo L2′. An opening can be made on the second mirror at the receiving end 112 to allow the second echo L2′ to pass therethrough, while the remaining positions of the second receiving mirror 112 are used for reflecting the first echo L1′, as illustrated in FIG. 6.

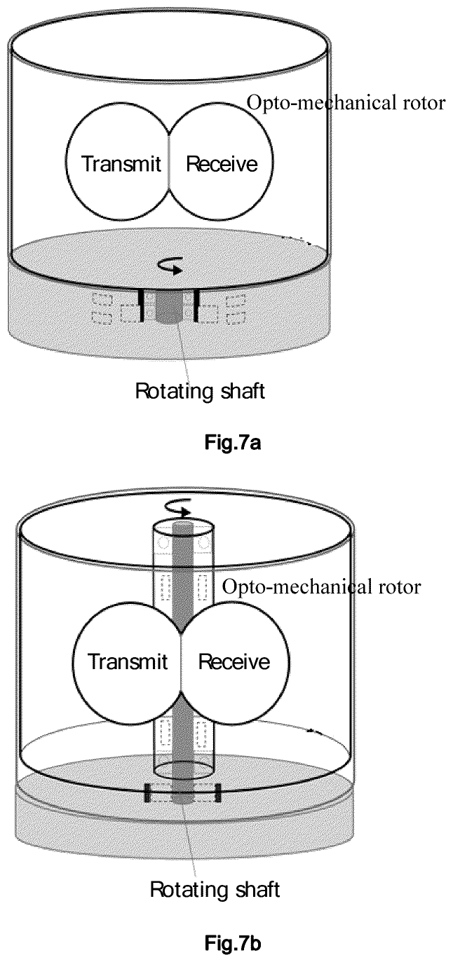

According to one preferred embodiment of the present disclosure, as illustrated in FIG. 7, the LiDAR has a rotating shaft and an opto-mechanical rotor rotatable about the rotating shaft. The optical and electronic components on the transmitting and receiving ends of the LiDARs illustrated in FIGS. 4a, 4b, 4c, 5 and 6 are all integrated in the opto-mechanical rotor. As illustrated in FIG. 7a, the opto-mechanical rotor is disposed above the rotating shaft, which means that the rotating shaft of the LiDAR does not protrude through the opto-mechanical rotor. With such a non-through structure, the rotating shaft does not extend into the opto-mechanical rotor, and thus can provide greater space for the opto-mechanical rotor for installing optical and electronic components, or can reduce the volume of the opto-mechanical and the volume of the LiDAR in the case of the same elements and components. Certainly, the present disclosure is not limited to such LiDAR with a non-through structure, and the rotating shaft of the LiDAR can also extend through the opto-mechanical rotor, as illustrated in FIG. 7b. Such through-shaft structure is more conducive to rotational stability. These all fall within the scope of protection of the present disclosure. Particularly preferably, the LiDAR in the embodiment of FIG. 5 has a non-through-shaft structure, and the LiDAR in the embodiment of FIG. 6 has a through-shaft structure.

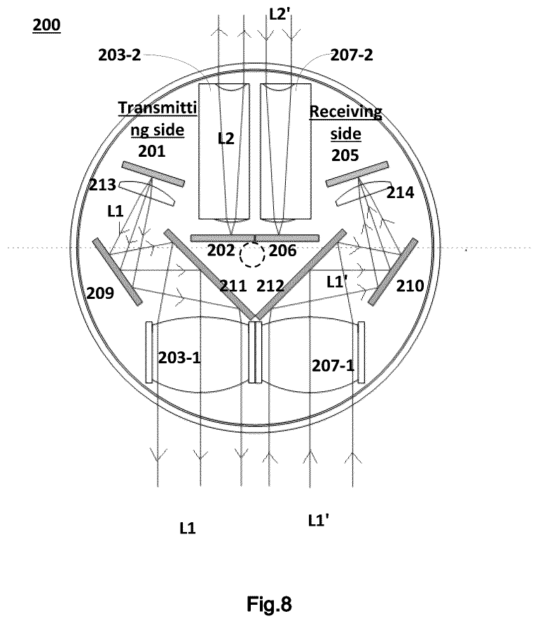

FIG. 8 illustrates a LiDAR 200 according to another embodiment of the present disclosure. In the embodiment of FIG. 8, a first detection laser beam and a second detection laser beam emitted by a first transmitting unit and a second transmitting unit of the LiDAR respectively exit after passing through different transmitting lenses. Correspondingly, a first echo and a second echo are respectively received by a first receiving unit and a second receiving unit after passing through different receiving lenses. Similarly, a transmit-receive pair consisting of the first transmitting unit and the first receiving unit (for long-range detection) and a transmit-receive pair consisting of the second transmitting unit and the second receiving unit (for short-range detection) correspond to different focal lengths, as described below in detail referring to FIG. 8.

As illustrated in FIG. 8, the LiDAR 200 on the transmitting side comprises a first transmitting unit 201 and a second transmitting unit 202, configured to respectively emit a first detection laser beam L1 and a second detection laser beam L2 to detect objects. An optical assembly at the transmitting end comprises a first transmitting lens 203-1 and a second transmitting lens 203-2, used respectively for modulating the first detection laser beam L1 and the second detection laser beam L2, and then enabling them to exit to the outside of the LiDAR 200. Additionally, the LiDAR 200 on the transmitting side further comprises a first mirror at the transmitting end 209 and a second mirror at the transmitting end 211, disposed in sequence between the first transmitting unit 201 and the first transmitting lens 203-1, and used for reflecting the first detection laser beam L1 in sequence. Those skilled in the art readily understand that the first mirror at the transmitting end 209 and the second mirror at the transmitting end 211 are not necessary, and it is also possible not to install the mirror at the transmitting ends, or other numbers of mirror at the transmitting ends can be provided as long as the requirements of an optical path and the layout requirements of a mechanical structure can be met. In FIG. 8, the second detection laser beam L2 emitted by the second transmitting unit 202 is directly incident onto the second transmitting lens 203-2, and exits after modulation (e.g., collimation). One or more mirrors can also be disposed between the second transmitting unit 202 and the second transmitting lens 203-2. These all fall within the scope of protection of the present disclosure. As illustrated in FIG. 8, the first transmitting lens 203-1 and the second transmitting lens 203-2 are substantially 180 degrees opposed about the rotating shaft of the LiDAR (as illustrated by the black circle in FIG. 8). With the structure in FIG. 8, the optical path structure used for short-range detection and the optical path structure used for long-range detection are independent of each other. Compared with the structures of the preceding embodiments, the structure in FIG. 8 may be installed and adjusted in a more convenient manner. Additionally, relative arrangement at 180 degrees can facilitate design and subsequent signal processing, and the data on short-range and long-range detection have an angle difference of 180 degrees in the horizontal direction. The first transmitting unit 201 is arranged, for example, on a focal plane of the first transmitting lens 203-1, and the second transmitting unit 202 is arranged, for example, on a focal plane of the second transmitting lens 203-2.

As illustrated in FIG. 8, the LiDAR 200 on the receiving side comprises a first receiving unit 205 and a second receiving unit 206, configured to respectively receive a first echo L1′ and a second echo L2′ of the first detection laser beam L1 and second detection laser beam L2 reflected by the objects, and convert them into electrical signals. A optical assembly at the receiving end comprises a first receiving lens 207-1 and a second receiving lens 207-2, used respectively for receiving the first echo L1′ and the second echo L2′. As illustrated in FIG. 8, the first receiving lens 207-1 can be arranged next to the first transmitting lens 203-1, and the second receiving lens 207-2 can be arranged next to the second transmitting lens 203-2. Additionally, the LiDAR 200 on the receiving side further comprises a first mirror at the receiving end 210 and a second mirror at the receiving end 212, disposed in sequence between the first receiving unit 205 and the first receiving lens 207-1, and used for reflecting the first echo L1′ in sequence. Those skilled in the art readily understand that the first mirror at the receiving end 210 and the second mirror at the receiving end 212 are not necessary, and it is also possible not to install the mirror at the receiving ends, or other numbers of mirror at the receiving ends can be provided as long as the requirements of an optical path and the layout requirements of a mechanical structure can be met. In FIG. 8, the second echo L2′ is directly converged to the second receiving unit 206 after passing through the receiving lens 207-2, and converted into an electrical signal. One or more mirrors can also be disposed between the second receiving unit 206 and the second receiving lens 207-2. These all fall within the scope of protection of the present disclosure. As illustrated in FIG. 8, the first receiving lens 207-1 and the second receiving lens 207-2 are substantially 180 degree opposed about the rotating shaft of the LiDAR (as illustrated by the black circle in the center of FIG. 8). The first receiving unit 205 is arranged, for example, on a focal plane of the first receiving lens 207-1, and the second receiving unit 206 is arranged, for example, on a focal plane of the second receiving lens 207-2. The LiDAR 200 illustrated in FIG. 8 can be in a through-shaft structure, or in a non-through-shaft structure, and preferably in a non-through-shaft structure.

As illustrated in FIG. 8, the first detection laser beam L1 and the second detection laser beam L2 respectively exit from the first transmitting unit 201 and the second transmitting unit 202, and travel through different optical distances before reaching the first transmitting lens 203-1 and the second transmitting lens 203-2. The first echo and the second echo respectively travel through different optical distances from the receiving lens before reaching the first receiving unit and the second receiving unit.

In the embodiment of FIG. 8, the first transmitting lens 203-1, for example, has a relatively large focal length, and the first receiving lens 207-1, for example, has a relatively large focal length, both combined with the first transmitting unit 201 and the first receiving unit 205 for long-range small-FOV detection; and the second transmitting lens 203-2, for example, has a relatively small focal length, and the second receiving lens 207-2, for example, has a relatively small focal length, both combined with the second transmitting unit 202 and the second receiving unit 206 for short-range large-FOV detection.

According to one preferred embodiment of the present disclosure, the lasers in the first transmitting unit 201 and the second transmitting unit 202 include a vertical cavity surface emitting laser (VCSEL) configured to emit light in a direction vertical to a PCB. The detectors (arrays) in the first receiving unit 205 and the second receiving unit 206, for example, include a single photon detector, such as SiPM or SPAD array. Additionally, photoelectric devices used for short-range detection and photoelectric devices used for long-range detection can share a rotating platform for performing power supply and signal transmission in a wireless manner. Preferably, in the embodiment illustrated in FIG. 8, the LiDAR 200 is in a non-through-shaft structure (as illustrated in FIG. 7a), that is, the rotating shaft of the LiDAR does not protrude from the rotor, in order to increase the space of the rotor to accommodate the short-range measuring module and the long-range measuring module.

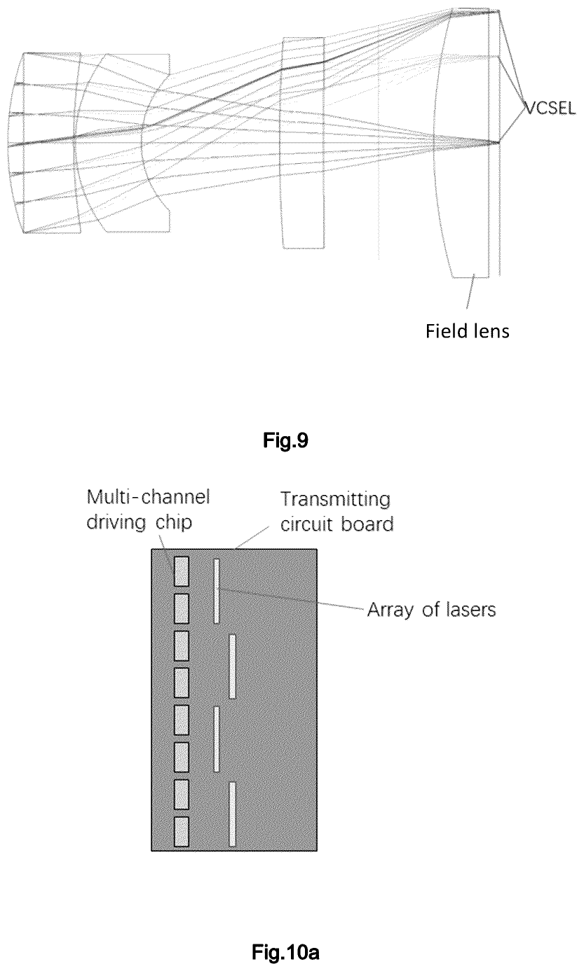

According to one preferred embodiment of the present disclosure, the first transmitting lens 203-1 and the first receiving lens 207-1 are preferably a telecentric lens group, for example, as illustrated in FIG. 9, which can reduce the overall lens height and make the structure more compact. A first field lens 213 can be disposed downstream of the optical path of the first transmitting unit 201 in the proximity of the focal plane of the first transmitting lens 203-1, and a second field lens 214 can be disposed upstream of the optical path of the first receiving unit 205 in the proximity of the focal plane of the first receiving lens 207-1. By disposing the first field lens 213 and the second field lens 214, the optical paths can be pulled back onto the optical axis. Meanwhile, the first transmitting lens 203-1 and the first receiving lens 207-1 for long-range detection have a long focal length, and a small vertical field of view, while the second transmitting lens 203-2 and the second receiving lens 207-2 for short-range detection have a short focal length, and a large vertical field of view. However, the focal plane heights of the two can be relatively close. Therefore, the height difference between the optical paths for long-range detection and short-range detection is not significant, enabling the overall height of the LiDAR to be very compact and reasonable.

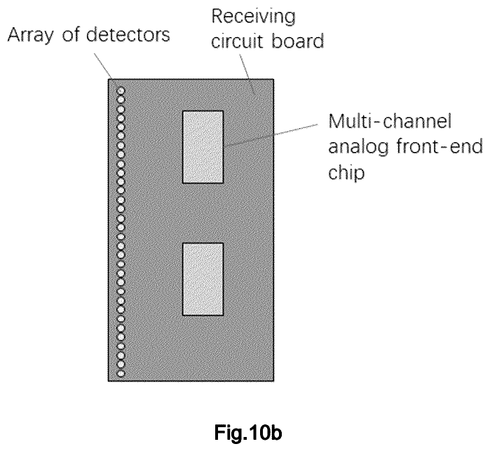

Additionally, preferably, the driving circuits of the array of lasers of the first transmitting units 101, 201 and the second transmitting units 102, 202 can be integrated on a chip (a multi-channel driving chip) respectively. For example, when the array of lasers includes 8 lasers, with the driving circuits of every 4 lasers integrated onto one multi-channel driving chip, the array of lasers thus correspond to two multi-channel driving chips, and a plurality of lasers and the corresponding multi-channel driving chips are disposed on the same PCB, as illustrated in FIG. 10a. Preferably, the readout circuits of the array of detectors of the first receiving units 105, 205 and the second receiving units 106, 206 are also integrated to a chip (a multi-channel analog front-end chip). For example, when the array of detectors includes 32 detectors, with the readout circuits of every 16 detectors integrated to one multi-channel analog front-end chip, the array of detectors thus correspond to two multi-channel analog front-end chips, and a plurality of detectors and the multi-channel analog front-end chips are disposed on the same PCB, as illustrated in FIG. 10b. In this way, the space occupied by the circuit part in the rotor can be further reduced, which is more conducive to accommodating the short-range and long-range measuring modules, enabling the LiDAR structure to be more compact.

The LiDAR of the present disclosure can also comprise a data processing unit coupled with the first and second transmitting units and the first and second receiving units, and fusing detection results of the first and second detection laser beams to generate a point cloud.

As can be seen from the aforesaid embodiments, the present disclosure adopts a bifocal length separation design, which satisfies both long-range detection at high resolution and small FOV, and short-range detection at low resolution and large FOV, while enables the heights of the lasers and detectors not to be increased significantly, and the structure to be compact, being conducive to the installation of the LiDAR on a vehicle.

The LiDAR according to the embodiment of the present disclosure integrates both large-FOV short-range detection and small-FOV long-range detection. By adopting a focus-changing structure, a large-FOV short-range detector is not necessarily at the same focal length as a long-range measuring detector, thereby enabling the height of the detector panel to be reduced greatly. For the solution of sharing a main lens, light beams of the two short-range and long-range measuring are emitted from the same set of transmit-receive main lenses. Therefore, the horizontal angle difference between the short-range and long-range detection will be very small, the time difference between the short-range and long-range detection in scanning the same object will be very small, and the point clouds of the short-range and long-range detection will be fused more easily.

The present disclosure proposes a solution that can satisfy both small-FOV long-range detection and large-FOV short-range detection. For a large-FOV short-range measuring detector, a focus-changing structure is adopted, so that it does not need to be at the same focal length as a long-range measuring detector, thereby greatly reducing the height of the large-FOV short-range measuring detector panel, and thereby enabling the height of the LiDAR not necessarily to be made very high and increasing the compactness of the overall structure.

Last but not least, it is noted that described above are just preferred embodiments of the present disclosure, which are not used to limit the present disclosure. Although the detailed description of the present disclosure has been provided with reference to the foregoing embodiments, those skilled in the art can still make modifications to the technical solution as recited in each of the foregoing embodiments, or conduct equivalent replacement of some technical features therein. Any modification, equivalent replacement, or improvement, if falling into the spirit and principles as stated herein, should be included in the scope of protection of the present disclosure.

We claim:

1. A LiDAR, comprising:
a first transmitting unit and a second transmitting unit, configured to respectively emit a first detection laser beam and a second detection laser beam for detecting an object;
an optical assembly at a transmitting end and an optical assembly at a receiving end, the optical assembly at the transmitting end comprising a transmitting lens, and the optical assembly at the receiving end comprising a receiving lens; and
a first receiving unit and a second receiving unit, configured to respectively receive a first echo and a second echo of the first detection laser beam and the second detection laser beam reflected by the object, and convert them into electrical signals,
wherein the first detection laser beam and the second detection laser beam respectively exit from the first transmitting unit and the second transmitting unit and then travel through different optical distances before reaching the transmitting lens, and the first echo and the second echo respectively travel through different optical distances from the receiving lens before reaching the first receiving unit and the second receiving unit.

2. The LiDAR of claim 1, wherein the first transmitting unit and the second transmitting unit are respectively disposed at different positions from the transmitting lens, and the first receiving unit and the second receiving unit are respectively disposed at different positions from the receiving lens.

3. The LiDAR of claim 1 or 2, wherein the first transmitting unit comprises a first array of lasers disposed on a focal plane of the transmitting lens; the second transmitting unit comprises a second array of lasers, a distance between the second array of lasers and the transmitting lens being less than a focal length of the transmitting lens; the first receiving unit comprises a first array of detectors disposed on a focal plane of the receiving lens; and the second receiving unit comprises a second array of detectors, a distance between the second array of detectors and the receiving lens being less than a focal length of the receiving lens.

4. The LiDAR of claim 1 or 2, wherein the second transmitting unit comprises a focus-changing lens at the transmitting end, disposed between the second array of lasers and the transmitting lens, the second detection laser beam passing through the focus-changing lens at the transmitting end and the transmitting lens before exiting to the outside of the LiDAR; the second receiving unit comprises a focus-changing lens at the receiving end, disposed between the second array of detectors and the receiving lens, the second echo passing through the receiving lens and the focus-changing lens at the receiving end before being incident onto the second array of detectors.

5. The LiDAR of claim 4, further comprising one or more mirror at the transmitting end and one or more mirror at the receiving end, the first detection laser beam being reflected by the mirror at the transmitting end and then exiting through the transmitting lens, and the first echo being reflected by the mirror at the receiving end and then being incident onto the first array of detectors.

6. The LiDAR of claim 5, wherein the mirror at the transmitting end comprises a mirror with an opening, wherein the first detection laser beam is reflected by the mirror with the opening at the transmitting end and then exits through the transmitting lens, and the second detection laser beam passes through the opening and exits through the transmitting lens; and
wherein the mirror at the receiving end comprises a mirror with an opening, wherein the first echo is reflected by the mirror with the opening at the receiving end and then incident onto the first array of detectors, and the second echo passes through the opening and is incident onto the second array of detectors.

7. The LiDAR of claim 1 or 2, wherein the LiDAR has a rotating shaft and an opto-mechanical rotor rotatable about the rotating shaft, the opto-mechanical rotor comprising the first transmitting unit, the second transmitting unit, the optical assembly at the transmitting end, the optical assembly at the receiving end, the first receiving unit and the second receiving unit, wherein the opto-mechanical rotor is disposed above the rotating shaft, or the rotating shaft extends through the opto-mechanical rotor.

8. The LiDAR of claim 1, wherein the optical assembly at the transmitting end comprises a first transmitting lens and a second transmitting lens, and the optical assembly at the receiving end comprises a first receiving lens and a second receiving lens, the first detection laser beam exiting through the first transmitting lens, and the second detection laser beam exiting through the second transmitting lens; and the first echo being converged to the first detection unit through the first receiving lens, and the second echo being converged to the second detection unit through the second receiving lens.

9. The LiDAR of claim 8, wherein the LiDAR has a rotating shaft, the first transmitting lens and the second transmitting lens being substantially 180 degree opposed about the rotating shaft, and the first receiving lens and the second receiving lens being substantially 180 degree opposed about the rotating shaft.

10. The LiDAR of claims 8 or 9, wherein the first transmitting lens and the first receiving lens comprise a telecentric lens group.

11. The LiDAR of any one of claims 1, 2, 8 or 9, wherein the first detection laser beam and the second detection laser beam correspond to different vertical field of view ranges of the LiDAR.

12. The LiDAR of any one of claims 1, 2, 8 or 9, wherein the energy of the first detection laser beam is higher than that of the second detection laser beam.

13. The LiDAR of any one of claims 1, 2, 8 or 9, wherein the first transmitting unit and the second transmitting unit both comprise a plurality of lasers and multi-channel driving chips, the plurality of lasers and multi-channel driving chips being disposed on the same PCB; and the first receiving unit and the second receiving unit both comprise a plurality of detectors and multi-channel front-end chips, the plurality of detectors and multi-channel front-end chips being disposed on the same PCB.

14. The LiDAR of any one of claims 1, 2, 8 or 9, further comprising a data processing unit coupled with the first transmitting unit, the second transmitting unit, the first receiving unit and the second receiving unit, and the data processing unit is used for fusing detection results of the first detection laser beam and the second detection laser beam to generate a point cloud.
